(19) United States
(12) Patent Application Publication
(10) Pub. No.: US 2026/0313207 A1
(43) Pub. Date: Oct. 8, 2026

(54) METHOD OF JOINT VIEWING REMOTE MULTIMEDIA CONTENT

(71) Applicant: G-Core Innovations S.à.r.l, Contern (LU)

(72) Inventors: Alexey PETROVSKIKH, Contern (LU); Artem MYZNIKOV, Contern (LU); Dmitri TKACH, Contern (LU)

(73) Assignee: G-Core Innovations S.à.r.l, Contern (LU)

(21) Appl. No.: 19/108,264

(22) PCT Filed: Sep. 2, 2022
(86) PCT No.: PCT/EP2022/074519

§ 371 Date: Mar. 3, 2025

(51) Int. Cl. H04N 21/6332; H04L 12/18; H04N 21/472; H04N 21/858

(52) U.S. Cl. CPC H04N 21/6332; H04L 12/1822; H04N 21/472; H04N 21/8586

(57) ABSTRACT

A computer implemented method for joint viewing of multimedia content during a video conferencing session comprising, by a server: establishing a video conferencing session between a first video conferencing software instance of a first participant device and at least a second video conferencing software instance of a second participant device via the server; receiving video conferencing content from each of the participant devices and providing said video conferencing content to each other participant device; receiving a uniform resource locator, URL, for multimedia content intended to be played by the participant devices engaged in the video conferencing session from the first participant device; providing signalling to each of the video conferencing software instances configured to cause each of the video conferencing software instances running on respective participant devices to access the multimedia content at the URL.

The present disclosure relates to a computer-implemented method for the joint viewing of multimedia content. More specifically, the present disclosure relates to computer-implemented methods performed by a server, a first participant device and a system, a server itself and a computer program product each for joint viewing of multimedia content during a video conferencing session, such that the video conference participants can view the same video contemporaneously.

### BACKGROUND OF THE INVENTION

Video conferencing has been gaining in popularity as a virtual way to meet others when meeting up in the real world is not possible. However, user interaction and sharing during virtual meetings may be limited compared to a real-world meeting. It is therefore important for video conferencing to provide functionality that approximates a real-world meeting so as to provide a shared experience for the participants.

### SUMMARY OF THE INVENTION

According to a first aspect there is provided a computer implemented method for joint viewing of multimedia content during a video conferencing session comprising, by a server:
establishing a video conferencing session between a first video conferencing software instance of a first participant device and at least a second video conferencing software instance of a second participant device via the server;
receiving video conferencing content from each of the participant devices and providing said video conferencing content to each other participant device;
receiving a uniform resource locator, URL, for multimedia content intended to be played by the participant devices engaged in the video conferencing session from the first participant device;
providing signalling to each of the video conferencing software instances configured to cause each of the video conferencing software instances running on respective participant devices to access the multimedia content at the URL.

The provision of a computer implemented method as provided for in the first aspect may beneficially allow for the joint viewing of multimedia content by participants in a video conferencing session by providing for low latency in the viewing of the multimedia content. This improves the social user experience and allows for interactivity during the joint viewing.

In one or more embodiments the computer implemented method may further comprise providing signalling to each of the video conferencing software instances configured to control a time of playback of the multimedia content for contemporaneous viewing of the multimedia content.

Synchronised viewing may be necessary in virtual training sessions or remote working scenarios where users need to be able to react contemporaneously. For example, where musicians are working together remotely based on multimedia content hosted online, it may be essential for the musicians to perform at the same time with respect to the multimedia content.

In one or more embodiments the multimedia content may be one or both of:
video content; and
audio content.

Advantageously, providing video and/or audio contents may provide participants of the video conferencing session with a virtual experience similar to watching TV or streaming videos together in, for example, a pub.

In one or more embodiments video conferencing content of a participant device comprises participant at least one of audio content and participant video content.

Advantageously, providing at least one of participant audio and video content better approximates a real-world meeting, in which a participant can share content for instance from their mobile phone with the other meeting participants.

In one or more embodiments the signalling configured to control a time of playback of the multimedia content is based on user control signalling from the first participant device.

Providing for user-based control of the time of playback may advantageously allow a user that is sharing the multimedia content, for example, to ensure that all other devices have properly loaded their multimedia content prior to playing the content. This may mimic an in-person real-life scenario where the user with a remote control initiates the playback of multimedia content. In other examples, the user may not provide for the control of the time of playback but this may be controlled automatically by the first participant device based on signalling received from the other participant devices indicating that their respective multimedia content is ready to be played.

In one or more embodiments the signalling configured to control a time of playback of the multimedia content is based on server control signalling from a central controller.

Providing for server-based control of the time of playback may advantageously provide for centralised control of playback. This may provide an experience similar to users watching a broadcast of the multimedia content and may also remove the burden from either a user or a user's device from handling management of the initiation of playback of the multimedia content. This approach may further reduce the latency as signalling to indicate readiness for playback and instructions to initiate playback do not need to do a roundtrip from the server to a participant device that would otherwise control playback.

In one or more embodiments the computer implemented method may further comprise the steps of receiving user control signalling from the first participant device and providing the user control signalling to each of the video conferencing software instances, wherein the user control signalling is configured to control a playback parameter of the multimedia content. The user control signalling may be received from the first participant by the server prior to initiation of playback of the multimedia content and provided to each of the video conferencing software instances such that the initial playback of the multimedia content is in line with the received playback parameters. The user control signalling may be received from the first participant by the server during playback of the multimedia content and provided to each of the video conferencing software instances such that a playback parameter of the multimedia content is changed during playback of the multimedia content.

In one or more embodiments the computer-implemented method may further comprise the step of providing default server control signalling from the server to each of the video conferencing software instances, wherein the default server control signalling may be configured to control a playback parameter of the multimedia content. The method may further comprise the step of providing server control signalling for a playback parameter in the absence of user control signalling corresponding to that playback parameter.

Providing functionality to allow a user to control a playback parameter of the multimedia content for all users may further enhance the joint-viewing experience. For example, this may allow a user to pause the multimedia content for all participants during a webinar so that the presenter can explain part of the multimedia content that has been experienced by the users. Alternatively, this may provide functionality to allow a user at a first participant device, such as a host, to set a skip period for the multimedia content in order to skip certain parts of the multimedia content during playback. Similarly, setting a skip period may allow the user to set a start-point for the multimedia prior to the initiation of playback which may allow the playback from a desired position part-way through the multimedia content. Allowing for central user control of such playback parameters provide for many potential advantages for enhancing the joint viewing experience and reducing latency between participants.

In one or more embodiments each playback parameter may be one of:
a speed of the playback of the multimedia content;
a direction of playback of the multimedia content;
a resolution of the multimedia content;
a skip period of the multimedia content;
an audio control of the multimedia content; and
a caption display setting of the multimedia content.

According to a second aspect there is provided a computer implemented method for the joint viewing of multimedia content during a video conferencing session comprising, by a first participant device:
establishing a video conferencing session between a first video conferencing software instance of the first participant device and at least a second video conferencing software instance of a second participant device via a server;
receiving video conferencing content from the second participant device via the server and providing video conferencing content to the second participant device via the server;
providing, to the server, a uniform resource locator, URL, for multimedia content intended to be shared to the participant devices engaged in the video conferencing session from the first participant device;
displaying the multimedia content.

According to a third aspect there is provided a computer implemented method for joint viewing of multimedia content during a video conferencing session comprising, by a system comprising a server and a plurality of participant devices comprising at least a first participant device and a second participant device:
establishing a video conferencing session between a first video conferencing software instance of a first participant device and at least a second video conferencing software instance of a second participant device via the server;
sending, by each of the participant devices, video conferencing content to the server;
receiving, by the server, the video conferencing content from each of the participant devices and providing said video conferencing content to each other participant device;
providing, by the first participant device to the server, a uniform resource locator, URL, for multimedia content intended to be shared to the participant devices engaged in the video conferencing session;
receiving, by the server, the URL for the multimedia content from the first participant device;
providing, by the server, signalling to each of the video conferencing software instances configured to cause each of the video conferencing software instances running on respective participant devices to access the multimedia content at the URL;
displaying, by each of the video conferencing software instances, the multimedia content.

According to a fourth aspect there is provided a server comprising a processor comprising means for carrying out embodiments of the computer implemented method described herein.

According to a fifth aspect there is provided a computer program product comprising computer program code configured to, when executed by a server comprising a processor, cause the server to carry out embodiments of the computer implemented method described herein.

### DESCRIPTION OF DRAWINGS

The embodiments of the invention, together with its advantages, may be best understood from the following detailed description taken in conjunction with the accompanying figures.

FIG. 1 shows an example screenshot of a conference call displaying multimedia content using the method described herein;

FIG. 2 shows a schematic drawing of the components of the system described herein;

FIG. 3 shows a flowchart of the method according to the present disclosure; and

FIG. 4 shows an example computer readable medium comprising computer program code configured to carry out the method of FIG. 3.

### DETAILED DESCRIPTION

The present disclosure relates to a method of joint viewing of multimedia content during a video conferencing session, such as a video conference call. The method allows the addition of multimedia content such as a video stream or an audio stream into a video conference call for contemporaneous viewing by all participants. Providing for this contemporaneous viewing not only reduces the latency between the viewing of the users, it also reduces latency experienced by each individual participant in general by allowing their participant devices to access the multimedia content from their local content delivery networks rather than the multimedia content being transmitted from a host participant.

It will be appreciated that while the word “viewing” may commonly relate to video content, in this case it is intended to also cover audio content. As such, viewing may be considered to be synonymous with “consuming” or otherwise experiencing the media content.

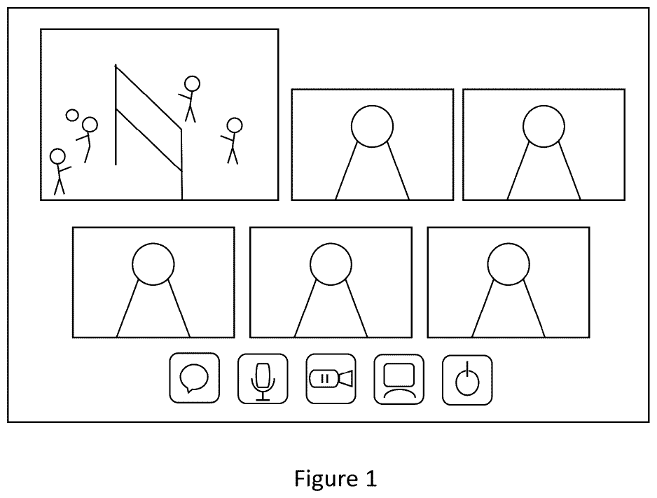

FIG. 1 shows an example screenshot from a video conferencing session. In this example, participants of the video conferencing session are watching a video stream of a sports tournament. In a scenario wherein a host streams the sports tournament from their device to other participants of the video conferencing session, each of the video conferencing software instances of the participants would present the sports tournament at different times depending on the time taken for the multimedia content to reach the participants. In embodiments according to the present disclosure, the video stream (or other multimedia content) is automatically retrieved and accessed by each video conferencing software instance of the video conferencing session separately. By providing for said separate retrieval of the multimedia content from the internet, the source of the video is chosen depending on their location and/or internet connection so as to minimise the latency. In some examples, the playback may be controlled so that all users watch the video at the same time.

The multimedia content may be, for instance, audio content, video content, augmented reality content, virtual reality content, a different type of multimedia content or any combination thereof. In particular, in line with the presented options, multimedia content refers herein to multimedia content that can change over time and that might be viewable synchronously by remote participants in a video conferencing session.

Video conferencing content may be, for example, one or more of audio content of a video conference participant or video content of a video conference participant. It will be appreciated that, during a video conferencing session, one or more, or even all, users may decide to not share video content and instead rely on audio content for the session. In other examples it will be appreciated that at times audio content may not be transmitted, either intentionally or unintentionally, by participants in a video conferencing session despite the provision of video content. For example, a video conferencing session between participants that are hard of hearing may choose to not transmit or receive audio content, as a conversation may take place entirely via video content.

In a video conferencing session, each participant must use a participant device in order to engage in the session. A participant device may be, for example, a personal computer, a laptop, a smart phone, a tablet computing device, or another suitable device which can run a video conferencing software instance.

In turn, a video conferencing software instance may be an occurrence of the running of a video conferencing computer program on a computer. There is a wide range of available video conferencing software which is commercially available and particular examples will not be presented here. The video conferencing software instance may comprise interactive elements in order to allow a participant to control aspects of the video conferencing instance such as an audio provision button, a video provision button, an end call button, a share screen button and a chat-toggle button.

A video conferencing session is provided by video conferencing software instances running on individual participant devices that connect to each other in order to provide video conferencing content to end users of the participant devices. In some embodiments, a video conferencing session may comprise a first participant device operating a first video conferencing software instance in communication with a second participant device operating a second video conferencing software instance. In other embodiments, there may be more than two participant devices and corresponding video conferencing software instances.

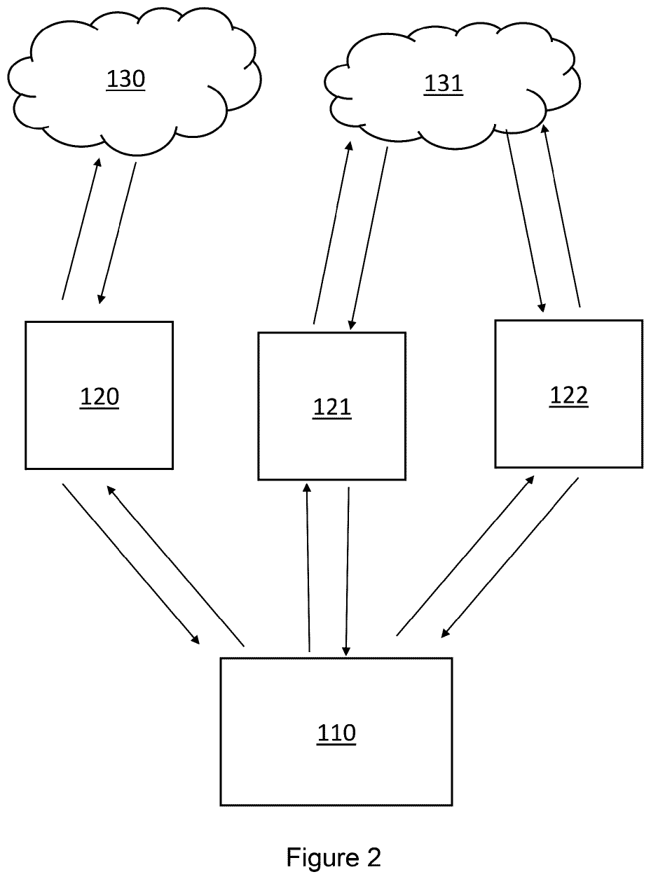

FIG. 2 shows a schematic representation of a system according to one or more embodiments of the present disclosure. The system 100 comprises a server 110 and a plurality of participant devices 120, 121, 122. The server 110 is configured to communicate with each of the participant devices 120, 121, 122. Each participant device 120, 121, 122 is configured to communicate with the server 110 and with a multimedia content source 130, 131. The multimedia content source 130, 131 may be different for each participant device 120, 121, 122 or more than one device may access the same multimedia content source. For example, where two participant devices in the video conferencing session are in the same or a similar geographical location, then they may access the multimedia content from a same multimedia content source. In contrast, geographically separated devices, or devices in a similar geographical location connected to the internet by different means may access multimedia content from different multimedia content sources. Further, devices of different technical specifications may be configured to access multimedia content in different ways or via different routes.

The multimedia content is preferably sourced from a content delivery network, CDN. A content delivery network comprises CDN servers in different geographical locations. The CDN servers are configured to cache content and deliver it across the network. When a user sends a request to access a web page, the nearest CDN server provides the content from its cache. In this way it is not necessary to access the origin server which hosts the original content. In some examples, however, the multimedia content may also be sourced from an original multimedia server, such as a video server.

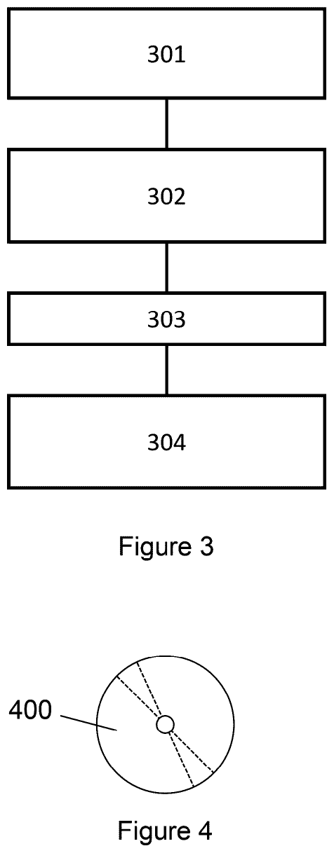

FIG. 3 shows a flowchart of a method for joint viewing multimedia content according to one or more embodiments of the present disclosure. In this context, the first participant is not directly sharing multimedia content from their own device to the other participants but, in contrast, is providing a direction to the other participant devices such that those participant devices can access the multimedia content themselves in way that the multimedia content can then be viewed jointly. The method comprises establishing 301 a video conferencing session between instances of video conferencing software via the server 110. As mentioned above, each video conferencing software instance is associated with one of the participant devices 120, 121, 122. The appearance of each video conferencing software instance may be the same on all participant devices 120, 121, 122 or it may differ depending on the type of device and the software the device is running. The server may establish the video conferencing session by receiving signalling from a first participant device indicative that a video conferencing session is desired with a second participant device and, in response, sending signalling to the second participant device in order to request the initiation of the video conferencing session. The server may then receive signalling from the second participant device indicative of an acceptance of the video conferencing session and, in response, establish a connection between the first participant device and the second participant device via the server. This may be analogous to the connection of a telephone call in typical telecommunications systems. In other examples, the server may arrange for the provision of signalling between any participant devices that join a prearranged digital “room”, i.e., between participant devices that provide signalling indicating that they have, or would like to, join the digital room. This approach may not require the sending and receiving of call request signalling and, instead, may be more analogous to users joining a virtual pre-defined meeting.

In step 302 the server 110 receives video conferencing content from each of the participant devices 120, 121, 122 and provides this received video conferencing content to each of the other participant devices 120, 121, 122. The provision of video conferencing content between participant devices 120, 121, 122 may occur once the video conferencing session has been established or as it is being established.

In step 303 the server 110 receives from the first participant device 120 a uniform resource locator, URL, for the multimedia content intended to be shared to the participant devices 120, 121, 122 during the video conferencing session. In this way, the sharing of the multimedia content comprises providing a link to the multimedia content that the first participant wishes to share and providing a system which allows the other participant devices to act upon receiving that link to integrate a multimedia content player into their respective video conferencing sessions. The first participant device 120 may be a host device for the video conferencing session or may be a non-host participant. In some embodiments, the video conferencing session may be configured to only allow a host participant to share multimedia content. The URL may be provided by a user of the first participant device 120 via a “share multimedia” functionality of the video conferencing software instance. In some instances, the user may input the URL into their respective video conferencing software instance. In other embodiments, the user may select an internet browser window which they wish to share and the video conferencing software instance may be configured to obtain the URL from the internet browser automatically. In yet other embodiments, the video conferencing software instance may comprise functionality that allows a user to share multimedia content from a program or application different from the video conferencing software instance such as by using a “share” button which then provides the user with an option to share (provide for joint viewing of) the multimedia content with remote participants via the video conferencing software instance.

It will be appreciated that the server 110 may or may not provide the URL to the first participant device 120, since the first participant device 120 already has the URL. The URL may be provided to the first participant device 120 in some embodiments in order to ensure the first participant device 120 is viewing the expected content. In other embodiments, it may not provide the URL to the first participant device 120 in order to avoid sending unnecessary data. As such, “providing signalling to each of the video conferencing software instances configured to cause each of the video conferencing software instances running on respective participant devices to access the multimedia content at the URL” may encompass embodiments where this signalling is not provided to the first participant device 120 (because that device already has the URL and has already accessed the multimedia content) and those in which the server does provide the signalling to the first participant device 120. It will be appreciated that the URL may take various formats, such as absolute URLs and relative URLs. More particularly, the URL may comprise an address of a website including the content, a pair ID and a key, a direct .MP4/.M3U8 URL, or any other appropriate URL.

In step 304 the server 110 provides signalling to each of the video conferencing software instances. The signalling is configured to cause each of the video conferencing software instances to access the multimedia content at the URL. Since the multimedia content is preferably sourced from a content delivery network, each video conferencing software instance may access the multimedia content from a different CDN server. In embodiments where the multimedia content comprises video content, the individual video conferencing software instance in the video conferencing session may provide for the viewing of the multimedia content as a pane in the video conferencing software instance displayed to the user, such as that shown in FIG. 1. In examples wherein the multimedia content is audio content without video content, an audio player or digital audio display may be provided by the video conferencing software instance for viewing by the respective participant of the video conferencing session. Alternatively, in the case of audio only multimedia, no pane within the window may be provided to represent the audio content and, instead, the audio content may be provided in isolation to the users.

In a further optional step, the server 110 may provide signalling to each of the video conferencing software instances. The signalling is configured to control a time of playback of the multimedia content for contemporaneous viewing of the multimedia content and, as such, may be referred to as time-of-playback signalling. For example, the server 110 may provide time-of-playback signalling configured to cause the start of playback either immediately upon receiving the time-of-playback signalling or the time-of-playback signalling may indicate a time at which playback should begin, either in terms of time as defined by a computer clock or a delay from receiving the time-of-playback signalling. The time-of-playback signalling may be provided to each of the video conferencing software instances in response to receiving from each of the video conferencing software instances signalling indicative that the multimedia content has either finished buffering or has sufficiently buffered in order to allow for the initiation of playback of the multimedia content. Providing for the playback signalling may thereby improve the synchronicity with which users view the multimedia content.

The server 110 may also provide signalling to each of the video conferencing software instances indicative of one or more playback parameters. The playback parameter signalling may provide for control of playback parameters of the multimedia content beyond the initial control of controlling the start-time of playback described above. For example, the playback parameter signalling may be configured to control one or more of the following playback parameters: a speed of the playback of the multimedia content; a direction of playback of the multimedia content; a resolution of the multimedia content; a skip period of the multimedia content; an audio control of the multimedia content, such as volume up and down or mute and unmute; and a caption display setting of the multimedia content. In the case of controlling the speed of the playback of the multimedia content, this may be provided for by controlling a speed multiplier of the multimedia content or by controlling a number of frames per second. The direction of playback may relate to whether the multimedia content is being played in a forward direction (progressing naturally in time as the multimedia content may have originally been planned to be presented) or in a backward direction, such as a rewind function. Providing for control of the resolution of the multimedia content may allow for setting the resolution to a particular resolution or to an automatic resolution function which allows each individual video conferencing software instance to select a resolution based on current bandwidth levels of the respective participant device. A skip period of the multimedia content may cause the multimedia content to jump ahead or backwards by a predefined period as opposed to moving through content at an accelerated pace. This may allow for the skipping of undesirable portions of the multimedia content, such as scenes in a video. If the playback parameter signalling related to a skip period is provided prior to the initiation of playback, then playback of the multimedia content may be caused to begin from a point not at the beginning of the multimedia content. The playback parameter signalling may be provided alongside the playback signalling in step 350 or otherwise prior to initiation of playback and, in doing so, may control the selected playback parameters at the beginning of playback of the multimedia content. Alternatively, the playback signalling may be issued during playback of the multimedia content in order to control the playback of the multimedia content during viewing. By way of example, the playback parameter signalling may be configured to cause each video conferencing software instance to interact with an application programming interface (API) of a multimedia player which is providing for the viewing of the multimedia content.

One or both of the playback signalling and the playback parameter signalling may be based on user control signalling from the first user device 120. That is, for example, a host or other provider of the multimedia content in the video conferencing session may be able to provide for central control of the provision of the multimedia content of all participants. Additionally or alternatively, one or both of the playback signalling and the playback parameter signalling may be based on a control signal from another user device 121, 122 or from the server 110 or a combination of any of these. For example, the server 110 may provide default server control signalling configured to control one or more of the playback parameters. The default server control signalling may be used in instances where a signalling related on one or more of the available playback parameters has not been specified by a user in user control signalling. Default playback parameters provided by the server 110 by way of the default server control signalling may relate to default values for each of the playback parameters. For example, the default playback parameter for direction of playback of the multimedia content may be “forward” or a speed of playback may be “x1”. The default playback parameters may, instead, be predefined as the playback parameters that were most recently used for playing previous piece of multimedia content. One or both of the user control signalling and the control signal from the server 110 may be received prior to beginning of playback or during playback of the multimedia content.

FIG. 4 shows an example of a computer readable medium 400 comprising computer program code configured to cause a server to carry out the method of FIG. 3.

The disclosed method enables participants in a video conference call to jointly watch multimedia content, such as a video stream. The multimedia content may be controlled by the user who had provided the content, by the other users, and/or by the server. By providing each participant device (and therefore each user) with its own instance of the multimedia content but controlling its playback by signalling from the server 110 streaming latency is minimised for all users and at the same time the users are able to watch the same content at the same time. In this way users may share a similar experience online as they would in real life, for instance when watching TV in a pub or watching a live theatre performance streamed in a cinema.

1. A computer implemented method for the joint viewing of multimedia content during a video conferencing session comprising, by a server:
establishing a video conferencing session between a first video conferencing software instance of a first participant device and at least a second video conferencing software instance of a second participant device via the server;
receiving video conferencing content from each of the participant devices and providing said video conferencing content to each other participant device;
receiving a uniform resource locator, URL, for multimedia content intended to be played by the participant devices engaged in the video conferencing session from the first participant device; and
providing signalling to each of the video conferencing software instances configured to cause each of the video conferencing software instances running on respective participant devices to access the multimedia content at the URL.

2. The computer implemented method of claim 1, further comprising providing signalling to each of the video conferencing software instances configured to control a time of playback of the multimedia content for contemporaneous viewing of the multimedia content.

3. The computer implemented method of claim 1, wherein the multimedia content is one or both of:
video content; and
audio content.

4. The computer implemented method of claim 1, wherein video conferencing content of a participant device comprises participant audio content and participant video content.

5. The computer implemented method of claim 2, wherein the signalling configured to control a time of playback of the multimedia content is based on user control signalling from the first participant device.

6. The computer implemented method of claim 2, wherein the signalling configured to control a time of playback of the multimedia content is based on server control signalling from a central controller.

7. The computer implemented method of claim 1, further comprising:
receiving user control signalling from the first participant device; and
providing the user control signalling to each of the video conferencing software instances, wherein the user control signalling is configured to control a playback parameter of the multimedia content.

8. The computer implemented method of claim 7, wherein the user control signalling is received from the first participant device by the server prior to initiation of playback of the multimedia content and provided to each of the video conferencing software instances such that the initial playback of the multimedia content is in line with the received user control signalling.

9. The computer implemented method of claim 7, wherein the user control signalling is received from the first participant device by the server during playback of the multimedia content and provided to each of the video conferencing software instances such that a playback parameter of the multimedia content is changed during playback of the multimedia content.

10. The computer implemented method of claim 1, further any comprising the step of providing default server control signalling from the server to each of the video conferencing software instances, wherein the default server control signalling is configured to control a playback parameter of the multimedia content.

11. The computer implemented method of claim 7, wherein:
the playback parameter is a first playback parameter of a plurality of playback parameters; and
the method further comprises
providing, in an absence of user control signaling corresponding to a second playback parameter of the plurality of playback parameters, default server control signalling for the second playback parameter.

12. The computer implemented method of claim 7 wherein each playback parameter is one of:
a speed of playback of the multimedia content;
a direction of playback of the multimedia content;
a resolution of the multimedia content;
a skip period of the multimedia content;
an audio control of the multimedia content; or a caption display setting of the multimedia content.

13. A computer implemented method for joint viewing of multimedia content during a video conferencing session comprising, by a first participant device:
establishing a video conferencing session between a first video conferencing software instance of the first participant device and at least a second video conferencing software instance of a second participant device via a server;
receiving video conferencing content from the second participant device via the server and providing video conferencing content to the second participant device via the server;
providing, to the server, a uniform resource locator, URL, for multimedia content intended to be played by the participant devices engaged in the video conferencing session from the first participant device; and
displaying the multimedia content.

14. A computer implemented method for joint viewing of multimedia content during a video conferencing session comprising, by a system comprising a server and a plurality of participant devices comprising at least a first participant device and a second participant device:
establishing a video conferencing session between a first video conferencing software instance of a first participant device and at least a second video conferencing software instance of a second participant device via the server;
sending, by each of the participant devices, video conferencing content to the server;
receiving, by the server, the video conferencing content from each of the participant devices and providing said video conferencing content to each other participant device;
providing, by the first participant device to the server, a uniform resource locator, URL, for multimedia content intended to be played by the participant devices engaged in the video conferencing session;
receiving, by the server, the URL for the multimedia content from the first participant device;
providing, by the server, signalling to each of the video conferencing software instances configured to cause each of the video conferencing software instances running on respective participant devices to access the multimedia content at the URL; and
displaying, by each of the video conferencing software instances, the multimedia content.

15. A server comprising a processor comprising means for carrying out the method of claim 1.

16. A computer program product comprising computer program code configured to, when executed by a server comprising a processor, cause the server to carry out the method of claim 1.
